(19) United States
(12) Patent Application Publication
(10) Pub. No.: US 2025/0176756 A1
(43) Pub. Date: Jun. 5, 2025

(54) CONTROL METHOD OF MILK WARMER FOR WARMING MILK

(71) Applicant: GUANGZHOU QINGKUAI INNOVATION TECHNOLOGY CO., LTD., GUANGZHOU (CN)

(72) Inventors: HUIHUANG XIE, GUANGZHOU (CN); JIAXIN TANG, GUANGZHOU (CN)

(21) Appl. No.: 18/958,055

(22) Filed: Nov. 25, 2024

(30) Foreign Application Priority Data
Dec. 4, 2023 (CN) 202311650330.0

(51) Int. Cl. A47J 36/24

(52) U.S. Cl. CPC A47J 36/2433

(57) ABSTRACT

A control method of a milk warmer for warming milk is provided. A processor of the milk warmer first executes a step of obtaining a milk state before executing a milk warming step. That is, the processor first obtains the milk state of the milk in a baby bottle, and then the processor executes a milk warming strategy corresponding to the milk state according to the milk state. Compared with a milk warmer in the prior art that uses a unified heating rule to heat a baby bottle, the milk warmer in the embodiments of the present disclosure has a higher heating accuracy for the milk in the baby bottle placed therein.

### TECHNICAL FIELD

The present disclosure relates to a technical field of milk warmers, and in particular to a control method of a milk warmer for warming milk.

### BACKGROUND

A milk warmer is configured to adjust a temperature of a liquid in a water tank of the milk warmer according to operations of users. The milk warmer is popular among a majority of users. When in use, a baby bottle storing milk is placed in the water tank of the milk warmer, and then the milk warmer heats the baby bottle placed in the water tank of the milk warmer. The milk warmer in the prior art heats the baby bottle placed in the water tank of the milk warmer according to a unified heating rule. However, in actual applications, hot and cold states of the milk stored in the baby bottle may be different. Only using the unified heating rule in the prior art to heat the baby bottle placed in the water tank of the milk warmer may result in inaccurate heating accuracy, causing a temperature of the milk in the baby bottle being too high or too low. For instance, a temperature of the baby bottle and the milk in a room temperature state may be too high when being heated according to the unified heating rule, or a temperature of the baby bottle and the milk in a refrigerated state may be too low when being heated according to the unified heating rule.

### SUMMARY

A processor of a milk warmer in embodiments of the present disclosure first executes a step of obtaining a milk state before executing a milk warming step. That is, the processor first obtains the milk state of the milk in a baby bottle, and then the processor executes a milk warming strategy corresponding to the milk state according to the milk state. Compared with a milk warmer in the prior art that uses a unified heating rule to heat a baby bottle, the milk warmer in the embodiments of the present disclosure has a higher heating accuracy for the milk in the baby bottle placed therein.

### BRIEF DESCRIPTION OF DRAWINGS

FIG. 1 is a schematic diagram of a milk warmer according to one embodiment of the present disclosure.

FIG. 2 is another schematic diagram of the milk warmer according to one embodiment of the present disclosure.

FIG. 3 is a cross-sectional schematic diagram of the milk warmer according to one embodiment of the present disclosure.

FIG. 4 is a schematic diagram of the milk warmer shown in a configuration of use according to one embodiment of the present disclosure.

FIG. 5 is a flow chart of a control method of the milk warmer for warming milk according to one embodiment of the present disclosure.

FIG. 6 is a flow chart of the control method of the milk warmer for warming milk according to one embodiment of the present disclosure.

FIG. 7 is a flow chart of the control method of the milk warmer for warming milk according to another embodiment of the present disclosure.

FIG. 8 is a flow chart of the control method of the milk warmer for warming milk according to another embodiment of the present disclosure.

FIG. 9 is a schematic diagram of a control system of the milk warmer for warming milk according to one embodiment of the present disclosure.

### DETAILED DESCRIPTION

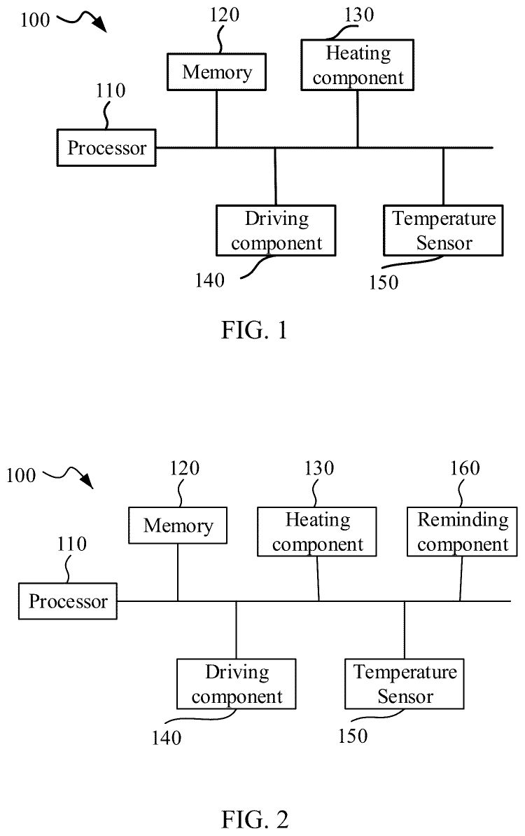

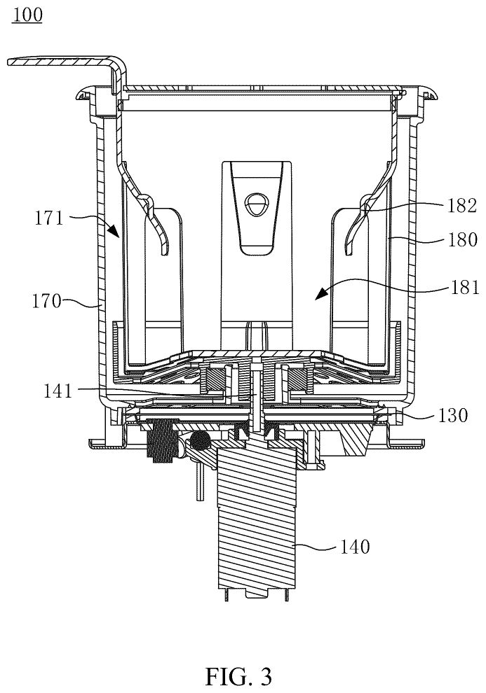

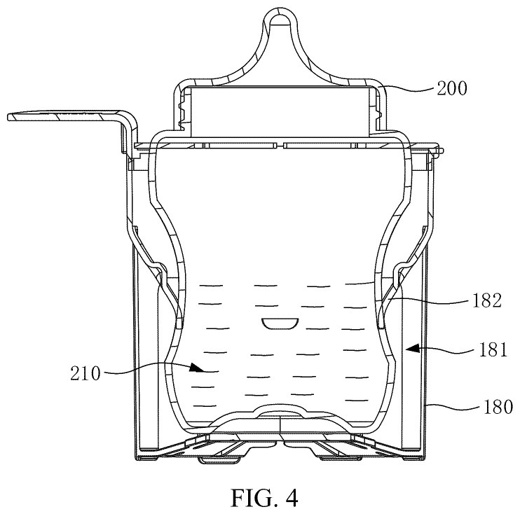

As shown in FIGS. 1, 3, and 4, a milk warmer of the present disclosure includes a processor 110, a memory 120, a driving component 140, a milk shaking component 180, a heating component 130, and a heating box 170. The processor 110 is electrically connected to the driving component 140, the memory 120, and the heating component 130. The milk shaking component 180 is placed in a cavity 171 of the heating box 170 from an opening of the heating box 170. The driving component 140 is connected to the milk shaking component 180. The driving component 140 is drivingly connected to the milk-shaking component 180. That is, the driving component 140 is connected to the milk shaking component 180, and the driving component 140 is configured to drive the milk shaking component 180. Specifically, the driving component 140 drives the milk shaking component 180 to move under control of the processor 110.

For instance, the milk shaking component 180 and the driving component 140 are connected through a rotating shaft 141. That is, the driving component 140 is fixed to the milk shaking component 180 through the rotating shaft 141. The driving component 140 is disposed below the heating box 170 and the heating component 130. The rotating shaft 141 passes through a bottom portion of the heating box 170 and is fixed to the milk shaking component 180. In one embodiment, the driving component 140 is a motor, and the rotating shaft 141 is a motor shaft of the driving component 140. In another embodiment, the driving component 140 includes a driving motor and a driving shaft, and the rotating shaft 141 is fixedly connected to the driving shaft of the driving component 140.

The heating box 170 is configured to store a liquid, such as pure water. The heating component 130 is disposed in the heating box 170. For instance, the heating component 130 is disposed on a bottom outer surface of the heating box 170, and the heating component 130 is configured to heat the liquid in the heating box 170 under the control of the processor 110. It is understood that the bottom portion of the heating box 170 has thermal conductivity. It should be understood that the heating component 130 maybe disposed at other positions of the heating box 170, such as the heating component 130 is disposed on a bottom inner surface of the heating box 170.

It is also understandable that the milk warmer 100 may further include one or more sealing components. The one or more sealing components are disposed on the heating box 170 to seal one or more hole structures defined in the heating box 170 to prevent the liquid in the heating box 170 from leakage.

When the liquid is stored in the heating box 170, the liquid in the heating box 170 is allowed to enter a storage space 181 of the milk shaking component 180. For instance, the shaking component 180 defines openings or through hole structures that are communicated to the cavity 171 of the heating box 170. When the baby bottle 200 is placed in the storage space 181 of the shaking component 180, the liquid in the heating box 170 is in contact with an outer surface of the baby bottle 200. In a process of the heating component 130 heating the liquid in the heating box 170, a temperature of the liquid in the heating box 170 gradually increases. The liquid in the heating box 170 transfers heat to the baby bottle 200, and heats the milk 210 in the baby bottle 200 through the baby bottle 200.

In order to improve efficiency of the milk warmer 100 in heating the milk 210 in the baby bottle 200, in one embodiment of the present disclosure, the processor 110 is configured to control the driving component 140 to drive the milk shaking component 180 and the baby bottle 200 placed in the store space 181 of the milk shaking component 180 to move together (e.g., rotating together) while controlling the heating component 130 to heat the liquid in the heating box 170. It should be noted that the driving component 140 drives the milk shaking component 180 to move in a manner other than rotation, such as a swinging manner, which is not limited thereto.

In order to improve stability of the baby bottle 200 placed in the store space 181 of the milk shaking component 180, in one optional embodiment of the present disclosure, the milk shaking component 180 includes deformable limiting structures 182. When the baby bottle 200 is placed in the milk shaking component 180, the baby bottle 200 drives the deformable limiting structures 182 to deform. After the baby bottle 200 is placed in the milk shaking component 182, the deformable limiting structures 182 generate a reverse force for the baby bottle 200 placed in the milk shaking component 180 to limit shaking of the baby bottle 200 in the milk shaking component 180, thereby improving the stability of the baby bottle 200 placed in the milk shaking component 180.

Specifically, an electrical connection between any two components described in the embodiments of the present disclosure indicates that the two components may be directly electrically connected to each other, or the two components may be indirectly electrically connected to each other. For example, a direct electrical connection may include one of following cases: the two components are electrically connected via a wire, the two components are electrically connected by abutting against each other, and the two components are electrically connected by welding, such as the processor 110 and the memory 120 are electrically connected via the wire. An indirect electrical connection indicates that another component may be connected between the two components, e.g., a resistor or other components being electrically connected between the processor 110 and the heating component 130.

The memory 120 stores programs, which are known as information. For example, the memory 120 stores a milk warming strategy. The milk warming strategy may include different strategies.

For instance, the milk warming strategy includes a duration strategy and/or a temperature strategy. In one embodiment, the processor 110 controls a working state of the heating component 130 and/or the driving component 140 according to the duration strategy. In another embodiment, the processor 110 controls the working state of the heating component 130 and/or the driving component 140 according to the temperature strategy. In another embodiment, the processor 110 controls the working state of the heating component 130 according to the temperature strategy, and the processor 110 controls the working state of the driving component 140 according to the duration strategy.

In one optional embodiment of the present disclosure, the milk warming strategy includes at least a milk state of the milk 210 in the baby bottle 200. The milk state is one of a refrigerated state and a room temperature state. It is understood that a temperature of the milk 210 in the refrigerated state is lower than a temperature of the milk 210 in the room temperature state. For example, when the milk 210 is in the refrigerated state, the temperature of the milk 210 is 3-6° C., such as 3° C., 4° C., 5° C., 6° C., etc. When the milk 210 is in the room temperature state, the temperature of the milk 210 is 22-26° C., such as 22° C., 23° C., 24° C., 25° C., 26° C., etc.

In one optional embodiment of the present disclosure, the milk warming strategy further includes a material of the baby bottle 200, and the material of the baby bottle 200 is one of glass, silicone, and plastic.

In one optional embodiment of the present disclosure, the milk warming strategy further includes an amount of the milk 210, and the amount of milk 210 is determined according to a capacity of the baby bottle 200. Namely, the amount of milk 210 is within the capacity of the baby bottle 200. For example, the capacity of the baby bottle 200 is 2-8 Oz, and the amount of milk 210 is 2-8 Oz, where Oz represents ounces.

The processor 110 is able to obtain the programs from the memory 120 and execute the programs obtained from the memory 120. The processor 110 is also able to obtain the programs from other components and execute the programs. For example, as shown in FIG. 2, the milk warmer 100 further includes a reminding component 160. The reminding component 160 includes at least one operation button. The processor 110 is able to obtain operation programs from the at least one operation button. The operation programs may include a startup program for starting the milk warmer 100, and the startup program is defined as a milk warming program. When the processor 110 obtains the milk warming program from the at least one operation button, the processor 110 first obtains the milk state of the milk 210 in the baby bottle 200 placed in the milk shaking component 180, then the processor 110 obtains the milk warming strategy from the memory 120 according to the milk state of the milk 210, and the processor 110 controls the heating component 130 and the driving component 140 to move according to the milk warming strategy.

When the processor 110 obtains the milk state of the milk 210 according to the milk warming program, the processor 110 controls the driving component 140 to move. Specifically, the processor 110 controls the driving component 140 to drive the milk shaking component 180 and the baby bottle 200 placed in the milk shaking component 180 to move together, and obtains a temperature change value of the liquid in the heating box 170 during a process thereof. The, the processor 110 determines the milk state of the milk 210 according to the temperature change value. The processor 110 determines a target strategy from the milk warming strategy stored in the memory 120 according to the milk state of the milk 210, and controls the heating component 130 to heat the milk in the heating box 170 according to the target strategy. Meanwhile, the processor 110 continuously controls the driving component 140 to drive the milk shaking component 180 and the baby bottle 200 placed in the milk shaking component 180 to move together. The processor 110 of the embodiment of the present disclosure first executes a milk state obtaining step before executing a milk warming step. That is, the processor 110 first obtains the milk state of the milk 210 in the baby bottle 200, and then executes the milk warming strategy corresponding to the milk state according to the milk state of the milk 210. Compared with a milk warmer in the prior art that uses a unified heating rule to heat a baby bottle, the milk warmer in the embodiments of the present disclosure has a higher heating accuracy for the milk in the baby bottle placed therein.

The temperature change value is understood as a temperature change value of the liquid in the heating box 170 when the processor 110 controls the driving component 140 to drive the milk shaking component 180 and the baby bottle 200 placed in the milk shaking component 180 to move together, without controlling the heating component 130 to heat. Exemplarily, as shown in FIG. 2, the milk warmer 100 further includes a temperature sensor 150 disposed in the heating box 170. When the liquid is stored in the cavity 171 of the heating box 170, the temperature sensor 150 is covered by the liquid in the heating box 170. The temperature sensor 150 is electrically connected to the processor 110, and the temperature sensor 150 is configured to detect a temperature of the liquid in the heating box 170.

The processor 110 is configured to control the temperature sensor 150 to detect the temperature of the liquid in the heating box 170, and obtain the temperature of the liquid in the heating box 170 from the temperature sensor 150. For instance, when the processor 110 controls the driving component 140 to drive the milk shaking component 180 and the baby bottle 200 placed in the milk shaking component 180 to move together, without controlling the heating component 130 to work, the temperature sensor 150 detects temperatures of the liquid in the heating box 170 at different time points, and the processor 110 is able to calculate a temperature difference after obtaining the temperatures at different time points, thereby determining the temperature change value.

For instance, the temperature sensor 150 and the milk shaking component 180 are spaced apart from each other. When the baby bottle 200 is placed in the milk shaking component 180, the temperature sensor 150 and the baby bottle 200 are spaced apart from each other so that the temperature of the liquid in the heating box 170 detected by the temperature sensor 150 is more accurate.

For instance, the milk shaking component 180 is disposed above the heating component 130, the milk shaking component 180 is disposed on a middle of the bottom portion of the heating box 170, and the temperature sensor 150 is disposed on an edge of the heating box 170.

The following describes a heating process of the milk 210 in the baby bottle 200 by the milk warmer 100 of the present disclosure in conjunction with a flow chart of heating the milk 210 in the baby bottle 200 by the milk warmer 100 of the present disclosure.

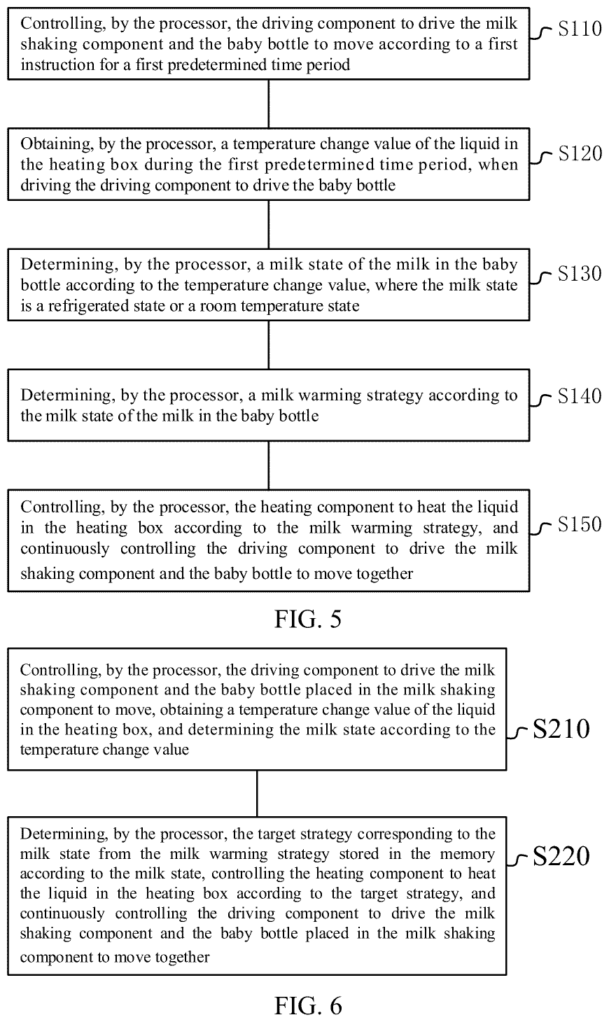

As shown in FIG. 5, a control method of a milk warmer 100 for warming milk includes steps S110-S150. The milk warmer 100 may refer to contents mentioned above and are not described in detail herein.

The step S110 includes controlling, by the processor, the driving component 140 to drive the milk shaking component 180 and the baby bottle 200 to move according to a first instruction for a first predetermined time period. The processor 110 is able to obtain the first instruction from other components of the milk warmer 100. In one case, the processor 110 obtains the first instruction from the at least one operation button of the milk warmer 100. Specifically, the processor 110 is electrically connected to the at least one operation button, and the at least one operation button transmits the first instruction to the processor 110 when the at least one operation button is triggered. In another case, the processor 110 obtains the first instruction from a touch screen of the milk warmer 100. Specifically, the processor 110 is electrically connected to the touch screen, and the touch screen transmits the first instruction to the processor 110 when the touch screen is triggered. In another case, the processor 110 obtains the first instruction from a pressure sensor of the milk warmer 100. For example, a pressure sensor is disposed on an inner surface of a bottom portion of the milk shaking component 180, and the pressure sensor is electrically connected to the processor 110. The baby bottle 200 is placed in the milk shaking component 180 to trigger the pressure sensor, and the pressure sensor transmits information that the baby bottle 200 is placed in the milk shaking component 180 to the processor 110.

The step S120 includes obtaining, by the processor 110, the temperature change value of the liquid in the heating box 170 during the first predetermined time period, when driving the driving component 140 to drive the baby bottle 200. The first predetermined time period is determined according to actual needs. For example, the first predetermined time period is 15 seconds, 16 seconds, or 17 seconds. It should be noted that the first predetermined time period is less than 60 seconds. If the first predetermined time period is less than 15 seconds, a time period for the milk shaking component 180 to move with the baby bottle 200 (e.g., rotate with the baby bottle 200), is too short, and the temperature change value detected by the temperature sensor 150 in a case of less than 15 seconds is not accurate enough. If the first predetermined time is greater than 60 seconds, the baby bottle 200 is placed in the milk shaking component 180 for too long, affecting the use. The processor 110 of the present disclosure is able to determine of the milk state of the milk 210 in the baby bottle 200 by automatically controlling the milk shaking component 180 and the baby bottle 200 to move within a relatively short prescribed time period after the baby bottle 200 is placed in the milk shaking component 180, without a need for manual identification or manual input of the milk state of the milk 210 in the baby bottle 200.

The step S130 includes determining, by the processor, the milk state of the milk in the baby bottle according to the temperature change value, where the milk state is the refrigerated state or the room temperature state.

The step S140 includes determining, by the processor 110, a milk warming strategy according to the milk state of the milk 210 in the baby bottle 200. The milk warming strategy is stored in the memory 120, and details may be found in the contents mentioned above, which are not described herein.

The step S150 includes controlling, by the processor 11, the heating component 130 to heat the liquid in the heating box 170 according to the milk warming strategy, and continuously controlling the driving component 140 to drive the milk shaking component 180 and the baby bottle 200 to move.

The step S150 specifically includes when the processor 110 determines that the milk state of the milk 210 in the baby bottle 200 is the refrigerated state, controlling the driving component 140 to drive the milk shaking component 180 and the baby bottle 200 to move together for a second predetermined time period according to the milk warming strategy and/or controlling the heating component 130 to heat the liquid in the heating box 170 according to the second predetermined time period.

The step S150 specifically includes when the processor 110 determines that the milk state of the milk 210 in the baby bottle 200 is the room temperature state, controlling the driving component to drive the milk shaking component 180 and the baby bottle 200 to mover for a third predetermined time period according to the milk warming strategy and/or controlling the heating component 130 to heat the liquid in the heating box 170 according to the third predetermined time period.

Specifically, the second predetermined time period is greater than the third predetermined time period.

In one optional embodiment of the present disclosure, the processor 110 controls the driving component 140 to drive the milk shaking component 180 and the baby bottle 200 to rotate at a first rotating speed in the first predetermined time period. The processor 110 controls the driving component 140 to drive the milk shaking component 180 and the baby bottle 200 to rotate at a second rotating speed in the second predetermined time period or the third predetermined time period. The first rotating speed is not less than the second rotating speed.

In one optional embodiment of the present disclosure, the processor 110 controls the driving component 140 to drive the milk shaking component 180 and the baby bottle 200 to rotate according to a first power in the first predetermined time period. The processor 110 controls the driving component 140 to drive the milk shaking component 180 and the baby bottle 200 to rotate according to a second power in the second predetermined time period or the third predetermined time period. The first power is not less than the second power.

For instance, the processor 110 first controls the heating component 130 to stop heating the liquid in the heating box 170, and then controls the driving component 140 to stop driving the milk shaking component 180 and the baby bottle 200 to move.

For instance, the temperature sensor 150 obtains a current temperature of the liquid in the heating box 170, and the processor 110 compares the current temperature of the liquid in the heating box 170 with a temperature defined in the milk warming strategy. When the current temperature is less than the temperature defined in the milk warming strategy, the processor 110 controls the heating component 130 to continue heating the liquid in the heating box 170. When the current temperature is not less than the temperature defined in the milk warming strategy, the processor 110 controls the heating component 130 to stop heating the liquid in the heating box 170.

For instance, after the processor 110 completes warming of the milk 210 according to the milk warming strategy, that is, the processor 110 controls the heating component 130 to stop heating the liquid in the heating box 170 and controls the driving component to stop rotating. In a fourth predetermined time period after the milk warmer 100 completes the warming of the milk 210, the processor 110 obtains that the baby bottle 200 is still placed in the milk shaking component 180, and the processor 110 controls the reminding component 160 to send reminding information to remind the user of a specific situation of the milk warmer 100 warming the milk 210. The reminding component 160 may include one or more of at least one operation button, a speaker, a display screen, and an indicator light. For instance, when the processor 110 controls the reminding component 160 to send the reminding information, the speaker emits a sound, and/or at least one of the indicator light, the display screen, and the at least one operation button displays a predetermined light. Specifically, the speaker emits a “drip, drip, drip” sound within a specified time period. Specifically, at least one of the at least one operation button, the indicator light, and the display screen is displayed as a flashing green breathing light within the specified time period. The specified time period is, for example, 1 minute to 3 minutes.

Before the step of controlling, by the processor 110, the heating component 130 to heat the liquid in the heating box 170 according to the milk warming strategy and continuously controlling the driving component 140 to drive the milk shaking component 180 and the baby bottle 200 to move, the control method further includes obtaining, by the process 110, the material of the baby bottle 200 placed and or the amount of the milk 210 in the baby bottle 200. The processor 110 further determines the milk warming strategy according to the material of the baby bottle 200 and/or the amount of milk 210 in the baby bottle 200. In one optional embodiment of the present disclosure, the processor 110 determines the milk warming strategy according to the milk state of the milk 210, the material of the baby bottle 200, and the amount of the milk 210 in the baby bottle 200.

The processor 110 drives the baby bottle 200 to move through the driving component 140, and processor 110 automatically determines the milk state of the milk 210 in the baby bottle 200, then the processor 110 retrieves the target strategy corresponding to the milk state of the milk 210 in the baby bottle 200 from the memory 120. The processor 110 controls a motion time for continuing to drive the baby bottle 200 to move and a heating temperature according to the target strategy.

For example, when the processor 110 determines that the milk 210 is refrigerated milk, the processor 110 automatically determines that the refrigerated milk requires a longer heating time and a longer milk shaking time than room temperature milk, so the processor 110 automatically selects the target strategy corresponding to the refrigerated milk from the milk warming strategy to drive the baby bottle 200 to move and control the heating component 130 to heat. When the processor 110 determines that the milk 210 is the room temperature milk, the processor 110 automatically determines that the room temperature milk requires a shorter heating time and a shorter milk shaking time than the refrigerated milk, so the processor 110 automatically selects a target strategy corresponding to the room temperature milk from the milk warming strategy to drive the baby bottle 200 to move and control the heating component 130 to heat.

Before warming the milk 210 in the baby bottle 200, the processor 110 first controls the driving component 140 to drive the milk shaking component 180 and the baby bottle 200 to move, so as to determine the milk state of the milk 210 in the baby bottle 200. Based on this, the present disclosure divides a process of warming the milk 210 by the milk warmer 100 into the milk state obtaining step and the milk warming step.

Specifically, as shown in FIG. 5, the control method includes steps S210-S220, that is, the milk state obtaining step and the milk warming step.

The milk state obtaining step S210 includes controlling, by the processor 110, the driving component 140 to drive the milk shaking component 180 and the baby bottle 200 placed in the milk shaking component 180 to move together, obtaining the temperature change value of the liquid in the heating box, and determining the milk state according to the temperature change value.

The milk warming step S220 includes: determining, by the processor 110, the target strategy corresponding to the milk state from the milk warming strategy stored in the memory 120 according to the milk state, controlling the heating component 130 to heat the liquid in the heating box 170 according to the target strategy, and continuously controlling the driving component 140 to drive the milk shaking component 180 and the baby bottle 200 placed in the milk shaking component to move together.

In one embodiment, the milk worming strategy includes the duration strategy. The milk warming step includes: determining, by the processor 110, a target duration corresponding to the milk state from the milk warming strategy stored in the memory 120 according to the milk state, and continuously controlling, according to the target duration, the driving component 140 to drive the milk shaking component 180 and the baby bottle 200 placed in the milk shaking component 180 to move together until the target duration ends.

In one embodiment, the milk warming strategy includes the temperature strategy. The milk warming step includes: determining, by the processor 110, a target temperature corresponding to the milk state from the memory 120 according to the milk state, and controlling the heating component 130 to heat the liquid in the heating box 170 according to the target temperature until the current temperature of the liquid in the heating box reaches the target temperature.

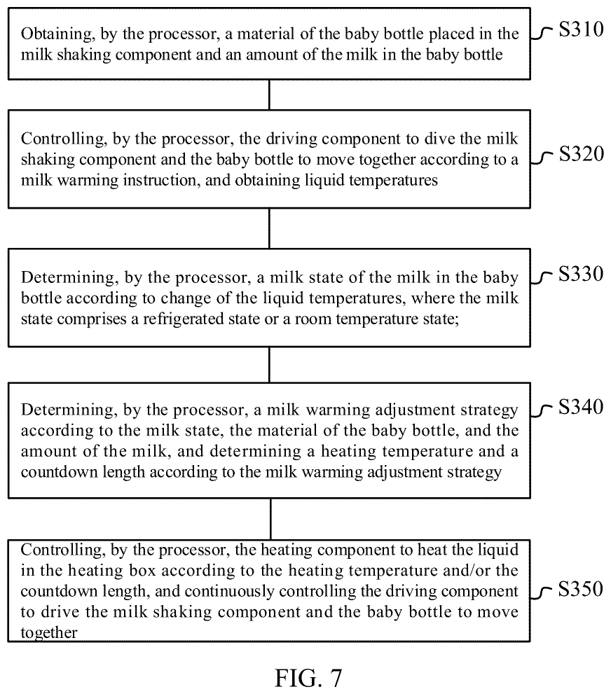

As shown in FIG. 7, the present disclosure provides a control method of a milk warmer for warming milk. The control method includes steps S310, S320, S330, S340, and S350. The milk warmer 100 may refer to the contents mentioned above and are not described in detail herein.

The step S310 includes obtaining, by the processor 110, the material of the baby bottle 200 placed in the milk shaking component 180 and the amount of the milk 210 in the baby bottle 200.

The step S320 includes controlling, by the processor 110, the driving component 140 to dive the milk shaking component 180 and the baby bottle 200 to move together according to a milk warming instruction, and obtaining liquid temperatures.

The step S330 includes determining, by the processor 110, the milk state of the milk 210 in the baby bottle 200 according to change of the liquid temperatures, where the milk state includes the refrigerated state or the room temperature state.

The step S340 includes determining, by the processor 110, a milk warming adjustment strategy according to the milk state, the material of the baby bottle, and the amount of the milk, and determining a heating temperature and a countdown length according to the milk warming adjustment strategy. The heating temperature is at least configured to represent a temperature of the liquid in the heating box 170, and the countdown length is at least configured to represent a control time of the processor 110 on the driving component 140.

The step S350 includes controlling, by the processor 110, the heating component 130 to heat the liquid in the heating box 170 according to the heating temperature and/or the countdown length, and continuously controlling the driving component 140 to drive the milk shaking component 180 and the baby bottle 200 to move together.

In one optional embodiment, the processor 110 first obtains the material of the baby bottle 200 and the amount of the milk 210. For example, in the embodiment of the present disclosure, at least one operation button or a touch screen is disposed on a housing of the milk warmer 100. When the user puts the baby bottle 200 into the milk warmer 100, the user may select the amount of the milk 210 and the material of the baby bottle 200 from the at least one operation button, or the user may input the amount of the milk 210 and the material of the baby bottle 200 from the touch screen. When the at least one operation button or the touch screen obtains operation information of the user or input information of the user, the operation information or the input information is transmitted to the processor 110.

In one embodiment, after the user puts the baby bottle 200 into the heating box 170, the user is able to select the material of the baby bottle 200 and the amount of milk 210 through the touch screen or the at least one operation button of the milk warmer 100. Then the milk warmer 100 enters a milk shaking working state and starts a milk shaking function of the milk warmer 100. The processor 110 first automatically identifies whether the milk state of the milk 210 is the refrigerated state or the room temperature state within a first predetermined time period (such as 15 seconds). After the processor 110 determines the milk state of the milk 210, the processor 110 determines the milk warming adjustment strategy according to the material of the baby bottle 200 and the amount of the milk 210, and determines the heating temperature and/or the countdown length according to the milk warming adjustment strategy. Then, the processor 110 automatically obtains the heating temperature and/or the countdown length. After the liquid in the heating box 170 is heated to the heating temperature, the processor 110 controls the heating component 130 to stop heating, and the liquid in the heating box 170 transfer heat to the milk 210 in the baby bottle 200 to heat up the milk, so that after the heating component 130 stops heating, if the baby bottle 200 is not taken out in time after the milk warmer 100 is turned off, the temperature of the milk 210 is not warmed to above 42° C. within a certain time period (for example, within 3 minutes). The temperature of the milk 210 does not reach 42° C., thereby avoiding a problem of the milk 210 being too hot.

The milk shaking working state of the milk warmer 100, or starting the milk shaking function of the milk warmer 100 is understood as: the processor 110 controls the driving component 140 to drive the milk shaking component 180 and the baby bottle 200 to move together such as rotate, while the processor 110 does not control the heating component 130 to work, or the processor 110 controls the heating component 130 to stop working.

When the processor 110 determines the milk state of the milk 210 within the first predetermined time period (such as 15 seconds,) the processor 110 only drives the baby bottle 200 to move, and does not control the heating component 130 to heat. A temperature change of the liquid in the heating box 170 when the milk 210 is in the refrigerated state is inconsistent with the temperature change of the liquid in the heating box 170 when the milk 210 is in the room temperature state. When the baby bottle 200 is driven to move, the liquid in the heating box 170 evenly transfers the heat transferred, so there is a large analog-to-digital (AD) value change (that is, the temperature change of the liquid in the heating box 170 is large). The temperature sensor 150 (NTC temperature sensor) in the heating box 170 detects the AD value change of the liquid, and the AD value change of the liquid for heating the refrigerated milk has big difference with the AD value change of the liquid for heating the room temperature milk, so the processor 110 is able to determine whether the milk 210 is in the refrigerated state or the room temperature state. After determining the milk state of the milk 210, the processor 110 automatically enters a default heating time countdown, and simultaneously heats and shakes the milk to promote rapid and uniform temperature rise of the milk.

In the embodiment, in the milk shaking working state, the AD value of the liquid changes greatly so that the processor 110 is able to automatically identify the milk state of the milk 210. According to an identification result, the processor 110 controls the hating component to accurately heat different amounts of the milk 210 and the baby bottle 200 of different materials, and the processor 110 sets different heating logics, so as to prevent the milk 210 from overheating.

Optionally, the step of controlling, by the processor 110, the driving component 140 to dive the milk shaking component 180 and the baby bottle to move together according to the milk warming instruction and obtaining the liquid temperatures includes following steps.

First, obtaining an accumulated duration by the processor 110 according to the milk warming instruction.

Then, obtaining the liquid temperatures between a first moment and a second moment by the processor, and averaging the liquid temperatures between the first moment and the second moment to determine a first value by the processor, where the first moment is configured to represent a moment when the accumulated duration reaches a first duration, the second moment is configured to represent a moment when the accumulated duration reaches a second duration, and the second duration is greater than the first duration.

Then, obtaining the liquid temperatures between a third moment and a fourth moment by the processor 110, and averaging the liquid temperatures between the third moment and the fourth moment to determine a second value by the processor; where the third moment is configured to represent a moment when the accumulated duration reaches a third duration, the fourth moment is configured to represent a moment when the accumulated duration reaches a fourth duration, the third duration is greater than the second duration, and the fourth duration is greater than the third duration.

Finally, obtaining the liquid temperatures between a fifth moment and a sixth moment by the processor, and averaging the liquid temperatures between the fifth moment and the sixth moment to determine a third value by the processor; where the fifth moment is configured to represent a moment when the accumulated duration reaches a fifth duration, the sixth moment is configured to represent a moment when the accumulated duration reaches a sixth duration, the fifth duration is greater than the fourth duration, and the sixth duration is greater than the fifth duration.

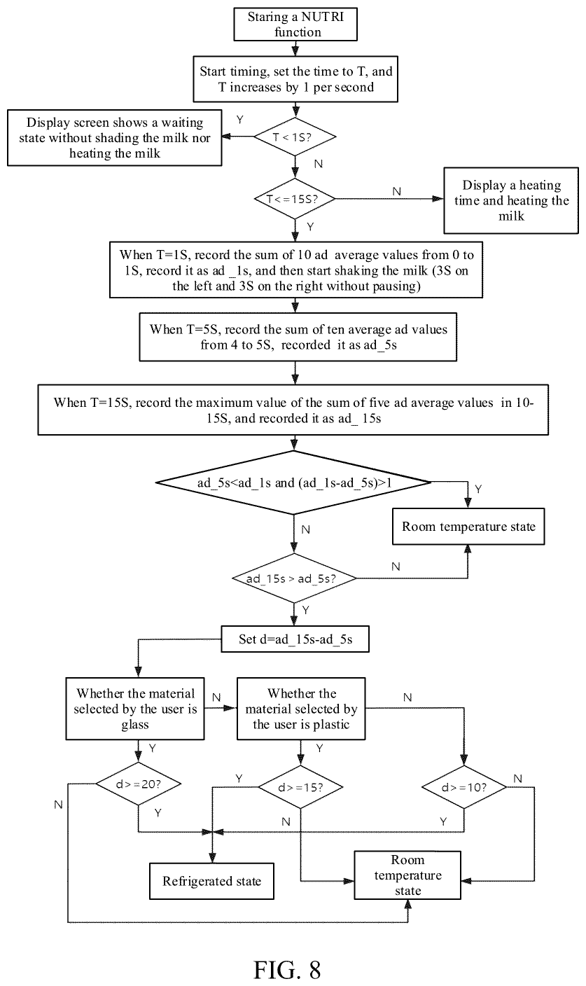

As shown in FIG. 8, in one embodiment, after the processor 110 controls the baby bottle 200 to move, the processor 110 starts timing, that is, the processor 110 obtains the accumulated duration. The accumulated duration is configured to represent a duration elapsed from a moment of receiving the milk warming instruction. It is understood that the temperature sensor 150 in the embodiment of the present disclosure is able to collect the liquid temperatures of different time periods. The processor 110 determines the change of the liquid temperatures based on the liquid temperatures of different time periods. For example, if the first duration is 0 seconds and the second duration is 1 second, the processor 110 obtains the liquid temperatures within the accumulated duration that is from the first duration to the second duration. Namely, the processor 110 obtains the liquid temperatures from the moment of receiving the milk warming instruction to the moment of 1 second from the moment of receiving the milk warming instruction, and obtains the first value after averaging. Similarly, the third duration is 4 seconds, the fourth duration is 5 seconds; the fifth duration is 10 seconds, and the sixth duration is 15 seconds.

It is understood that, for the embodiment shown in FIG. 8, the first moment is the moment of 0 seconds after receiving the milk warming instruction, the second moment is the moment of 1 second after receiving the milk warming instruction, the third moment is the moment of 4 seconds after receiving the milk warming instruction, the fourth moment is the moment of 5 seconds after receiving the milk warming instruction, the fifth moment is the moment of 10 seconds after receiving the milk warming instruction, and the sixth moment is the moment of 15 seconds after receiving the milk warming instruction. Specifically, the processor 110 averages the liquid temperatures within 1 second after receiving the milk warming instruction, and the liquid temperatures within 5 seconds are averaged in intervals and then a maximum value is taken for processing. Specifically, in an obtaining process shown in FIG. 8, the obtaining process specifically includes steps 1-3. The step 1 includes taking an AD value every 0.01 s. The step 2 includes taking an average value of 10 AD values obtained in the step 1 as an AD value for every 0.1 s. The step 3 includes taking a sum of 10 AD values for every 0.1 s obtained in the step 2 as an AD value for every 1 s. Exemplarily, the AD values of 0-1 second and 4-5 second are determined through a value-taking logic in the steps 1-3. The AD value of 0-1 second is used as a value of 1 s in Table 1; the AD value of 4-5 s is used as a value of 5 s in Table 1. Then, the AD values of 10˜11 s, 11˜12 s, 12˜13 s, 13˜14 s, and 14˜15 s are determined through the value-taking logic in the steps 1 to 3, and a plurality of AD values are obtained. Then a maximum value is taken as a value of 15 s in Table 1. Therefore, a judgment logic of the processor 110 of the embodiment of the present disclosure to determine the milk state of the milk 210 in the baby bottle 200 according to the change of the liquid temperatures includes the following steps.

First, the processor 110 receives the milk warming instruction, obtains the liquid temperatures in the first time period, averages the liquid temperatures in the first time period, and then performs a first sum operation to determine the first value in the first time period.

The processor 110 obtains the liquid temperatures in the second time period, averages the liquid temperatures in the second time period, and then performs a second sum operation to determine the second value in the second time period.

The processor 110 obtains the liquid temperatures in the third time period, averages the liquid temperatures in the third time period, and then performs a third sum operation and an extreme value operation to determine the third value in the third time period. The third time period is after the second time period, and the second time period is after the first time period.

Exemplarily, Table 1 shows different amounts of the milks 210 in the refrigerated state and data of the liquid temperatures of different baby bottles 200 of different materials. Table 2 shows different amounts of the milks 210 in the room temperature state and data of the liquid temperatures of different baby bottles 200 of different materials. Specifically, 1S is configured to represent the first value, 5S is configured to represent the second value, and 15S is configured to represent the third value. It is understood that the refrigerated state commonly indicates that the milk is between 0-4° C., and the room temperature state commonly indicates that the milk is about 22° C. Therefore, the embodiment of the present disclosure collects the liquid temperatures for a milk state where the temperature of the milk is 13-15° C., see Table 3 for reference. It is understood that the milk between 13-15° C. is in a median range between a refrigerating temperature 4° C. and a room temperature 22° C. In actual use, the processor 110 may judge the milk 210 between 13-15° C. as the milk in the refrigerated state and then execute a heating mode corresponding to the refrigerated state. Alternatively, the processor 110 may judge the milk 210 between 13-15° C. as the milk in the room temperature state and then execute a heating mode corresponding to the room temperature state. However, referring to some specific embodiments shown in Table 3, no matter which heating mode is adopted, since the milk is in the median temperature range (13-15 degrees Celsius), the temperature of the milk 210 heated by the control method of the present disclosure is at a drinkable temperature and does not exceed 42° C., which well meets the needs of the user. It should be noted that the liquid temperatures given in the tables are voltage values obtained by AD acquisition, which are configured to represent the temperature of the liquid in the heating box 170 of the milk warmer 100.

TABLE 1

| | Amount | 1 S | Δad(1 − 5 S) | 5 S | Δad(5 − 15 S) | 15 S |
|---|---|---|---|---|---|---|
| Refrigerated | 2 OZ | 5 | 4 | 9 | 10 | 19 |
| Silicone | 3 OZ | 13 | 8 | 21 | 18 | 39 |
| Baby Bottle | 4 OZ | 29 | 4 | 33 | 16 | 49 |
| | 5 OZ | 30 | 6 | 36 | 11 | 47 |
| | 6 OZ | 11 | 7 | 18 | 30 | 48 |
| | 7 OZ | 41 | 7 | 48 | 14 | 62 |
| | 8 OZ | 54 | 1 | 55 | 22 | 77 |
| Refrigerated | 2 OZ | 55 | 2 | 57 | 15 | 72 |
| Plastic | 3 OZ | 18 | 6 | 24 | 26 | 50 |
| Baby Bottle | 4 OZ | 47 | 6 | 53 | 18 | 71 |
| | 5 OZ | 47 | 2 | 49 | 16 | 65 |
| | 6 OZ | 52 | 2 | 54 | 15 | 69 |
| | 7 OZ | 53 | 2 | 55 | 17 | 72 |
| | 8 OZ | 50 | 10 | 60 | 17 | 77 |
| Refrigerated | 2 OZ | 7 | 5 | 12 | 41 | 53 |
| Glass | 3 OZ | 33 | 8 | 41 | 27 | 68 |
| Baby Bottle | 4 OZ | 60 | 8 | 68 | 27 | 95 |
| | 5 OZ | 31 | 10 | 41 | 58 | 99 |
| | 6 OZ | 76 | 3 | 79 | 20 | 99 |
| | 7 OZ | 45 | 16 | 61 | 42 | 103 |
| | 8 OZ | 57 | 5 | 62 | 47 | 109 |

TABLE 2

| | Amount | 1 S | Δad(1 − 5 S) | 5 S | Δad(5 − 15 S) | 15 S |
|---|---|---|---|---|---|---|
| Room | 2 OZ | 8 | −3 | 5 | 9 | 14 |
| Temperature | 3 OZ | 54 | 5 | 59 | 8 | 67 |
| Silicone | 4 OZ | 10 | −5 | 5 | 9 | 14 |
| Baby Bottle | 5 OZ | 7 | 7 | 14 | −1 | 13 |
| | 6 OZ | 4 | 3 | 7 | 5 | 12 |
| | 7 OZ | 53 | 3 | 56 | 6 | 62 |
| | 8 OZ | 49 | −2 | 47 | 5 | 52 |
| Room | 2 OZ | 29 | 10 | 39 | 8 | 47 |
| Temperature | 3 OZ | 31 | 1 | 32 | 8 | 40 |
| Plastic | 4 OZ | 24 | 3 | 27 | 13 | 40 |
| Baby Bottle | 5 OZ | 19 | 3 | 22 | 14 | 36 |
| | 6 OZ | 16 | 9 | 25 | 8 | 33 |
| | 7 OZ | 18 | 3 | 21 | 9 | 30 |
| | 8 OZ | 15 | 2 | 17 | 7 | 24 |
| Room | 2 OZ | 45 | 3 | 48 | 14 | 62 |
| Temperature | 3 OZ | 48 | −2 | 46 | 13 | 59 |
| Glass | 4 OZ | 42 | −3 | 39 | 19 | 58 |
| Baby Bottle | 5 OZ | 41 | 4 | 45 | 11 | 56 |
| | 6 OZ | 45 | −6 | 39 | 13 | 52 |
| | 7 OZ | 36 | 4 | 40 | 12 | 52 |
| | 8 OZ | 39 | −2 | 37 | 11 | 48 |

TABLE 3

| | Amount | 1 S | Δad(1 − 5 S) | 5 S | Δad(5 − 15 S) | 15 S |
|---|---|---|---|---|---|---|
| 13-15° C. | 2 OZ | 89 | 2 | 91 | 6 | 97 |
| Silicone | 3 OZ | 92 | −3 | 89 | 31 | 120 |
| Baby Bottle | 4 OZ | 22 | 9 | 31 | 8 | 39 |
| | 5 OZ | 49 | 2 | 51 | 1 | 52 |
| | 6 OZ | 7 | 5 | 12 | 46 | 58 |
| | 7 OZ | 15 | 10 | 25 | 36 | 61 |
| | 8 OZ | 48 | 1 | 49 | 23 | 72 |
| 13-15° C. | 2 OZ | 53 | 7 | 60 | 8 | 68 |
| Plastic | 3 OZ | 2 | 0 | 2 | 15 | 17 |
| Baby Bottle | 4 OZ | 8 | 5 | 13 | 18 | 31 |
| | 5 OZ | 15 | 1 | 16 | 26 | 42 |
| | 6 OZ | 36 | 3 | 39 | 15 | 54 |
| | 7 OZ | 42 | 10 | 52 | 13 | 65 |
| | 8 OZ | 49 | 8 | 57 | 17 | 74 |
| 13-15° C. | 2 OZ | 57 | 2 | 59 | 22 | 81 |
| Glass | 3 OZ | 73 | −2 | 71 | 19 | 90 |
| Baby Bottle | 4 OZ | 57 | 5 | 62 | 13 | 75 |
| | 5 OZ | 56 | 7 | 63 | 24 | 87 |
| | 6 OZ | 67 | 14 | 81 | 17 | 98 |
| | 7 OZ | 83 | −3 | 80 | 10 | 90 |
| | 8 OZ | 81 | 7 | 88 | 7 | 95 |

Optionally, the step of determining, by the processor 110, the milk state of the milk in the baby bottle 200 according to the change of the liquid temperatures includes: determining a first difference value according to the first value and the second value by the processor 110; determining a second difference value according to the second value and the third value by the processor 110; when the second value is less than the first value and the first difference value is greater than a first threshold, determining that the milk state is the room temperature state by the processor 110; when the third value is not greater than the second value, determining that the milk state is the room temperature state by the processor 110; when the third value is greater than the second value, determining the milk state by the processor 110 according to the material of the baby bottle 200 and the second difference value.

In some optional embodiments, the first difference value is determined according to the first value and the second value. As shown in Table 1, Δad(1-5S) represents the first difference value, Δad(5-15S) represents the second difference value, and the first threshold is 1, which are of course illustrative examples. It should be noted that Δad(1-5S) in Tables 1 to 3 is configured to represent ad_5s-ad_1s.

Optionally, the step of when the third value is greater than the second value, determining the milk state by the processor according to the material of the baby bottle and the second difference value includes: when the baby bottle 200 is made of glass and the second difference value is less than a second threshold, determining that the milk state is the room temperature state by the processor 100; when the baby bottle is made of plastic and the second difference value is less than a third threshold, determining that the milk state is the room temperature state by the processor 100, where the third threshold is less than the second threshold; when the baby bottle is not made of the glass or the plastic, and the second difference value is less than a fourth threshold, determining that the milk state is the room temperature state by the processor, where the fourth threshold is less than the third threshold.

In some optional embodiments, the second threshold is 20, the third threshold is 15, and the fourth threshold is 10. It is seen from Table 1 that the minimum value of the second difference value corresponding to the refrigerated silicone baby bottle (i.e., the baby bottle made of silicone where the milk therein is in the refrigerated state) is 10, so the second difference value is not less than the fourth threshold, and the milk is determined to be in the refrigerated state. Similarly, for the refrigerated plastic baby bottle, the minimum second difference value is 15. That is, the second difference value is not less than the third threshold, and the milk 210 is determined to be in the refrigerated state. For the refrigerated glass baby bottle, the minimum second difference value is 20, that is, the second difference value is not less than the second threshold, and the milk 210 is determined to be in the refrigerated state. It is seen from Table 2 that the maximum value of the second difference value of the room temperature silicone baby bottle 200 is 9, which meets the above judgment rules. The maximum value of the second difference value of the room temperature plastic baby bottle is 14, which meets the above judgment rules. The maximum value of the second difference value of the room temperature glass baby bottle 200 of is 19, which also meets the above judgment rules. Specific values of the above thresholds are exemplary examples.

Optionally, the step of determining, by the processor 110, the milk warming adjustment strategy according to the milk state, the material of the baby bottle 20, and the amount of the milk and determining the heating temperature and the countdown length according to the milk warming adjustment strategy includes: when the baby bottle 200 is made of glass, the amount of the milk is a first volume, and the milk state is the refrigerated state, determining that the heating temperature is a first heating temperature and the countdown length is a first countdown length by the processor 100; or when the baby bottle 200 is made of plastic, the amount of the milk is the first volume, and the milk state is the refrigerated state, determining that the heating temperature is a second heating temperature and the countdown length is a second countdown length by the processor, or when the baby bottle is made of silicone, the amount of the milk is the first volume, and the milk state is the refrigerated state, determining that the heating temperature is a third heating temperature and the countdown length is a third countdown length by the processor 110, or when the baby bottle is made of the glass, the amount of the milk is a second volume, and the milk state is the refrigerated state, determining that the heating temperature is a fourth heating temperature and the countdown length is a fourth countdown length by the processor; or when the baby bottle 200 is made of the glass, the amount of the milk is the second volume, and the milk state is the room temperature state, determining that the heating temperature is a fourth heating temperature and the countdown length is a fifth countdown length.

The second heating temperature is not less than the first heating temperature, the third heating temperature is not less than the second heating temperature, the second countdown length is greater than the first countdown length, the third countdown length is greater than the second countdown length, and the fourth countdown length is greater than the fifth countdown length.

In some optional embodiments, the milk warming adjustment strategy may be in a form of a table, and the heating temperature and the countdown length corresponding to the milk state, the material of the baby bottle 200, and the amount of the milk 210 are found through the table. The milk warming adjustment strategy may be in a form of a curve, and the heating temperature and the countdown length corresponding to the milk state, the material of the baby bottle 200, and the amount of the milk 210 are found through the curve. Of course, the milk warming adjustment strategy may be in a form of a formula, and the heating temperature and the countdown length corresponding to the milk state, the material of the baby bottle 200, and the amount of the milk 210 are calculated through the formula. The present disclosure does not limit the specific form of the milk warming adjustment strategy.

Exemplarily, referring to the milk warming adjustment strategy given in Tables 4 and 5, the heating temperature and the countdown length corresponding to the milk state, the material of the baby bottle 200, and the amount of the milk 210 are found through Tables 4 and 5. Table 4 shows correspondence between the material of the baby bottle 200, the amount of the milk 210, the heating temperature and the countdown length, when the milk is in the refrigerated state. Table 5 shows correspondence between the material of the baby bottle 200, the amount of the milk 210, the temperature and the countdown length, when the milk is in the room temperature state. The countdown length in the embodiment of the present disclosure is configured to represent a time required to shake and warm the milk when the material of the baby bottle 200, the amount of the milk 210, and the milk state of the milk 210 are determined. It should be noted that in the embodiments shown in Tables 4 and 5, the amount of the milk 210 is measured in ounces (OZ). It is understandable that the mount of the milk 210 may be measured in other units of measurement, which is not limited thereto. Similarly, the measurement of the heating temperature and the countdown length are predetermined as needed. The material of the baby bottle 200 and the amount of the milk 210 listed in Tables 4 and 5 are some common settings. Of course, the material of the baby bottle 200 and the amount of the milk 210 in Tables 4 and 5 may be adjusted according to the different usage habits of users in different regions.

Specifically, the heating temperature setting in Tables 4 and 5 is predetermined according to a time to heat the milk to a suitable temperature, an air pressure and other characteristics of different regions, and a time to heat the milk to no more than 42° C. The maximum heating temperature is the highest temperature that the heating box 170 can reach after stopping heating. The maximum heating temperature is not greater than 5° C. of the predetermined heating temperature. According to user usage habits, a suitable drinking temperature for the milk in the room temperature after being warmed is 37° C., and a suitable drinking temperature for the milk in the refrigerated state after being warmed is 31° C. Similarly, a temperature of dairy products exceeding 42° C. is easy to destroy original nutrients, so the maximum value after milk heating is set to be 42° C. The 37° C./min: s in the table represents the time required for the temperature of the milk to reach 37° C. The heating time is a normal level on the market, that is, the heating time is the countdown length in the embodiments of the present disclosure. The 42° C./min: s in Table 4 and Table 5 represents the time required for the milk to reach 42° C. A usage mode of the milk warmer 100 is set as “regardless of the material of the baby bottle or the milk state of the milk, once the milk reaches a stable drinking temperature, even if heating is continued, the temperature of the milk is not greater than 42° C. within 3 minutes”. It is seen from data in Table 4 and Table 5 that, through the control method of the present disclosure, the heating of the heating box is turned off after the temperature of the liquid in the heating box 170 reaches the predetermined heating temperature, and the maximum heating temperature is not too high, so the temperature of the milk 210 is not too high.

TABLE 4

| | | | Maximum | | |
|---|---|---|---|---|---|
| | | Predetermined | heating | | |
| | | heating | temperature/ | | |
| | Amount | temperature/° C. | ° C. | 31° C./min:s | 42° C./min:s |
| Refrigerated | 2 OZ | 45 | 48.7 | 3′01″ | 7′23″ |
| glass baby | 3 OZ | | 44.9 | 3′15″ | >12′00″ |
| bottle | 4 OZ | | 47.4 | 3′49″ | >12′00″ |
| | 5 OZ | 53 | 53.3 | 2′55″ | 8′11″ |
| | 6 OZ | | 54.1 | 4′51″ | >12′00″ |
| | 7 OZ | 58 | 59.0 | 4′01″ | >12′00″ |
| | 8 OZ | | 58.1 | 5′05″ | >12′00″ |
| Refrigerated | 2 OZ | 60 | 60.2 | 3′41″ | 8′17″ |
| plastic baby | 3 OZ | | 60.3 | 4′27″ | 11′01″ |
| bottle | 4 OZ | | 60.2 | 5′11″ | >12′00″ |
| | 5 OZ | 65 | 65.8 | 5′51″ | >12′00″ |
| | 6 OZ | | 65.5 | 7′05″ | >12′00″ |
| | 7 OZ | 70 | 70.2 | 6′47″ | >12′00″ |
| | 8 OZ | | 70.7 | 7′05″ | >12′00″ |
| Refrigerated | 2 OZ | 60 | 60.2 | 4′27″ | 11′00″ |
| silicone baby | 3 OZ | | 60.4 | 6′51″ | >12′00″ |
| bottle | 4 OZ | | 60.8 | 7′19″ | >12′00″ |
| | 5 OZ | 65 | 70 | 6′37″ | >12′00″ |
| | 6 OZ | | 70.1 | 8′15″ | >12′00″ |
| | 7 OZ | 75 | 75.8 | 7′51″ | >12′00″ |
| | 8 OZ | | 75.6 | 8′25″ | >12′00″ |

TABLE 5

| | | Predetermined | Maximum | | |
|---|---|---|---|---|---|
| | | heating | heating | | |
| | | temperature/ | temperature/ | | |
| | Amount | ° C. | ° C. | 31° C./min:s | 42° C./min:s |
| Room | 2 OZ | 45 | 47.3 | 2′43″ | 9′03″ |
| temperature | 3 OZ | | 46 | 3′28″ | >12′00″ |
| glass baby | 4 OZ | | 47.2 | 4′20″ | >12′00″ |
| bottle | 5 OZ | 53 | 54.2 | 3′17″ | 7′37″ |
| | 6 OZ | | 53.8 | 3′47″ | 9′49″ |
| | 7 OZ | 58 | 58.3 | 3′29″ | 7′01″ |
| | 8 OZ | | 58.2 | 3′31″ | 7′15″ |
| Room | 2 OZ | 60 | 60.7 | 3′35″ | 5′17″ |
| temperature | 3 OZ | | 60.5 | 4′15″ | 7′30″ |
| plastic baby | 4 OZ | | 60.6 | 4′53″ | 8′13″ |
| bottle | 5 OZ | 65 | 65.5 | 5′01″ | 8′59″ |
| | 6 OZ | | 65.2 | 6′19″ | 9′15″ |
| | 7 OZ | 70 | 70 | 5′35″ | 9′27″ |
| | 8 OZ | | 71.4 | 6′15″ | 9′43″ |
| Room | 2 OZ | 60 | 61 | 4′33″ | 8′20″ |
| temperature | 3 OZ | | 59.9 | 4′29″ | 8′43″ |
| silicone baby | 4 OZ | | 62.4 | 5′24″ | 10′01″ |
| bottle | 5 OZ | 65 | 64.9 | 6′09″ | 11′40″ |
| | 6 OZ | | 65.5 | 6′55″ | >12′00″ |
| | 7 OZ | 75 | 74.8 | 6′44″ | 11′55″ |
| | 8 OZ | | 74.9 | 7′50″ | >12′00″ |

The step of controlling, by the processor 110, the heating component 130 to heat the liquid in the heating box 170 according to the heating temperature and/or the countdown length and continuously controlling the driving component 140 to drive the milk shaking component 180 and the baby bottle 200 to move together includes: obtaining, by the processor 110, a current temperature of the liquid in the heating box; when the current temperature is less than the heating temperature, controlling the heating component to continue to heat the liquid in the heating box by the processor; when the current temperature is not less than the heating temperature, controlling the heating component to stop heating the liquid in the heating box by the processor; and controlling, by the processor 110, the driving component to drive the milk shaking component 180 and the baby bottle 200 to move within the countdown length; and when the countdown length ends, controlling the driving component 140 to stop driving the milk shaking component 180 and the baby bottle 200 to move by the processor 110.

In one optional embodiment, the processor 110 first controls the heating component 130 to stop heating the liquid in the heating box 170, and then controls the driving component 140 to stop driving the milk shaking component 180 and the baby bottle 200 to move. That is, after the processor 110 controls the heating component 130 to stop heating the liquid in the heating box 170, the processor 110 continues to control the driving component 140 to drive the milk shaking component 180 and the baby bottle 200 to move within a predetermined time period.

In one optional embodiment, the heating temperature in the embodiment of the present disclosure is configured to control a heating process, the countdown length is configured to control a milk shaking state, and the heat transfer between the liquid in the heating box 170 and the milk 210 is accelerated through shaking the milk.

In other optional embodiments, the step of controlling, by the processor 110, the heating component 130 to heat the liquid in the heating box 170 according to the heating temperature and/or the countdown length and continuously controlling the driving component 130 to drive the milk shaking component 180 and the baby bottle 200 to move together includes: within the countdown length, controlling the heating component 130 to heat the liquid in the heating box 170 and controlling he driving component 140 to drive the milk shaking component 180 and the baby bottle 200 to move together by the processor 110; when the countdown length ends, controlling the heating component 130 to stop heating the liquid in the heating box 170 and controlling the driving component 130 to stop driving the milk shaking component 180 and the baby bottle 200 to move by the processor 110; obtaining the current temperature of the liquid in the heating box by the processor 110, and when the current temperature is less than the heating temperature, controlling the heating component 130 to continue heating the liquid in the heating box 170 and controlling the driving component 130 to continue to drive the milk shaking component 180 and the baby bottle 200 to move by the processor 100; and when the current temperature is not less than the heating temperature, controlling the heating component 130 to stop heating the liquid in the heating box 170 and controlling the driving component 140 to stop driving the milk shaking component 180 and the baby bottle 200 to move by the processor 110.

Optionally, in the embodiment, when the heating box 170 is controlled to heat the liquid by the processor 110 according to the temperature detected by the negative temperature coefficient (NTC) temperature sensor, the heating temperature needs to be compensated and adjusted. Specifically, as shown in Table 6, the heating temperatures of the baby bottles 200 of different materials and the amount of milk 210 in the refrigerated state are compensated, and a compensated NTC trip temperature is configured to represent a predetermined temperature of the NTC temperature sensor. By measuring a current NTC temperature detected by the NTC temperature sensor in real time, the current temperature is compared with the predetermined temperature of the NTC temperature sensor to determine whether to turn off the heating component. In the embodiment of the present disclosure, in addition to the temperature sensor (the NTC temperature sensor) of the heating box 170, an external temperature sensor is disposed on an upper portion of the heating box 170. The predetermined temperature in Table 6 refers to a temperature detected by the external temperature sensor, that is, the heating temperature in the embodiment of the present disclosure. It is understood that since the NTC temperature sensor is disposed at a lower portion of the heating box, it is necessary to stop heating at a temperature greater than the predetermined heating temperature in order to make the liquid in the heating box 170 reach the predetermined heating temperature. Through experiments and observing the NTC temperature and the external temperature sensor at the same time, data in Tables 6 and 7 is obtained.

TABLE 6

| | | Predetermined | |
|---|---|---|---|
| | | Heating | NTC trip |
| | Amount | temperature /° C. | temperature/° C. |
| Refrigerated | 2 OZ-4 OZ | 45 | 49 |
| glass baby | 5 OZ-6 OZ | 53 | 57 |
| bottle (4° C.) | 7 OZ-8 OZ | 58 | 62 |
| Refrigerated | 2 OZ-4 OZ | 60 | 64 |
| plastic baby | 5 OZ-6 OZ | 65 | 69 |
| bottle (4° C.) | 7 OZ-8 OZ | 70 | 74 |
| Refrigerated | 2 OZ-4 OZ | 60 | 64 |
| silicone baby | 5 OZ-6 OZ | 65 | 69 |
| bottle (4° C.) | 7 OZ-8 OZ | 75 | 79 |

TABLE 7

| | | Predetermined | |
|---|---|---|---|
| | | Heating | NTC trip |
| | Amount | temperature /° C. | temperature/° C. |
| Room temperature | 2 OZ-4 OZ | 45 | 49 |
| glass baby | 5 OZ-6 OZ | 53 | 57 |
| bottle (22° C.) | 7 OZ-8 OZ | 58 | 62 |
| Room temperature | 2 OZ-4 OZ | 60 | 64 |
| plastic baby | 5 OZ-6 OZ | 65 | 69 |
| bottle (22° C.) | 7 OZ-8 OZ | 70 | 74 |
| Room temperature | 2 OZ-4 OZ | 60 | 64 |
| silicone baby | 5 OZ-6 OZ | 65 | 69 |
| bottle (22° C.) | 7 OZ-8 OZ | 75 | 79 |

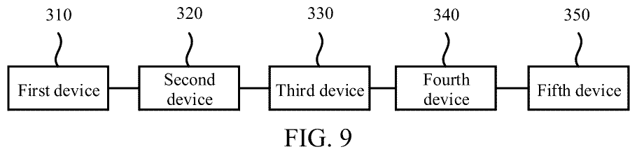

As shown in FIG. 9, the present disclosure provides a control system of the milk warmer. The control system includes a first device 310, a second device 320, a third device 330, a fourth device 340, and a fifth device 350.

The first device 310 is configured to obtain the material of the baby bottle placed in the milk shaking component 180 and the amount of the milk. The second device 320 is configured to control the driving component 140 to drive the milk shaking component 180 and the baby bottle placed in the milk shaking component 180 to move together according to the milk warming instruction, and obtain the liquid temperatures. The third device 330 is configured to determine the milk state of the milk in the baby bottle according to the change of the liquid temperature. The milk state of the milk is refrigerated state or the room temperature state. The fourth device 340 is configured to determine the milk warming adjustment strategy according to the milk state of the milk, the material of the baby bottle and the amount of the milk, and determine the heating temperature and/or the countdown length according to the milk warming adjustment strategy. The fifth device 350 is configured to control the heating component 130 to heat the liquid in the heating box 170 according to the heating temperature and/or the countdown length and is configured to continuously control the driving component 140 to drive the milk shaking component 180 and the baby bottle to move together.

The embodiment of the present disclosure further provides a computer-readable storage medium. The computer-readable storage medium stores a program executable by the processor. The program executable by the processor is configured to execute the control method of the milk warmer for warming milk when executed by the processor.

What is claimed is:

1. A control method of a milk warmer for warming milk, wherein the milk warmer comprises a processor, a driving component, a milk shaking component, a heating component, and a heating box, wherein the processor is electrically connected to the driving component and the heating component, the milk shaking component is disposed in the heating box, the driving component is connected to the milk shaking component, the processor is configured to control the driving component to drive the milk shaking component to move, the milk shaking component is configured to accommodate a baby bottle, the heating box is configured to store a liquid, the processor is configured to control the heating component to heat the liquid in the heating box, and when the liquid is stored in the heating box and the baby bottle is placed in the milk shaking component, the liquid in the heating box is in contact with an outer surface of the baby bottle; wherein the control method comprising steps:
obtaining, by the processor, a material of the baby bottle placed in the milk shaking component and an amount of the milk in the baby bottle;
controlling, by the processor, the driving component to dive the milk shaking component and the baby bottle to move according to a milk warming instruction, and obtaining liquid temperatures;
determining, by the processor, a milk state of the milk in the baby bottle according to change of the liquid temperatures, wherein the milk state comprises a refrigerated state or a room temperature state;
determining, by the processor, a milk warming adjustment strategy according to the milk state, the material of the baby bottle, and the amount of the milk, and determining a heating temperature and a countdown length according to the milk warming adjustment strategy, wherein the heating temperature is configured to represent a temperature of the liquid in the heating box, and the countdown length is at least configured to represent a control time of the processor on the driving component; and
controlling, by the processor, the heating component to heat the liquid in the heating box according to the heating temperature and/or the countdown length, and continuously controlling the driving component to drive the milk shaking component and the baby bottle to move.

2. The control method according to claim 1, wherein the step of controlling, by the processor, the driving component to dive the milk shaking component and the baby bottle to move according to the milk warming instruction and obtaining the liquid temperatures comprises:
obtaining an accumulated duration by the processor according to the milk warming instruction;
obtaining the liquid temperatures between a first moment and a second moment by the processor, and averaging the liquid temperatures between the first moment and the second moment to determine a first value by the processor, wherein the first moment is configured to represent a moment when the accumulated duration reaches a first duration, the second moment is configured to represent a moment when the accumulated duration reaches a second duration, and the second duration is greater than the first duration;
obtaining the liquid temperatures between a third moment and a fourth moment by the processor, and averaging the liquid temperatures between the third moment and the fourth moment to determine a second value by the processor; wherein the third moment is configured to represent a moment when the accumulated duration reaches a third duration, the fourth moment is configured to represent a moment when the accumulated duration reaches a fourth duration, the third duration is greater than the second duration, and the fourth duration is greater than the third duration; and
obtaining the liquid temperatures between a fifth moment and a sixth moment by the processor, and averaging the liquid temperatures between the fifth moment and the sixth moment to determine a third value by the processor; wherein the fifth moment is configured to represent a moment when the accumulated duration reaches a fifth duration, the sixth moment is configured to represent a moment when the accumulated duration reaches a sixth duration, the fifth duration is greater than the fourth duration, and the sixth duration is greater than the fifth duration.

3. The control method according to claim 2, wherein the step of determining, by the processor, the milk state of the milk in the baby bottle according to the change of the liquid temperatures comprises:
determining a first difference value according to the first value and the second value by the processor;
determining a second difference value according to the second value and the third value by the processor; and
when the second value is less than the first value and the first difference value is greater than a first threshold, determining that the milk state is the room temperature state by the processor; or when the third value is not greater than the second value, determining that the milk state is the room temperature state by the processor; or
when the third value is greater than the second value, determining the milk state by the processor according to the material of the baby bottle and the second difference value.

4. The control method according to claim 3, wherein the step of when the third value is greater than the second value, determining the milk state by the processor according to the material of the baby bottle and the second difference value comprises:
when the baby bottle is made of glass and the second difference value is less than a second threshold, determining that the milk state is the room temperature state by the processor; or
when the baby bottle is made of plastic and the second difference value is less than a third threshold, determining that the milk state is the room temperature state by the processor, wherein the third threshold is less than the second threshold; or
when the baby bottle is not made of the glass or the plastic, and the second difference value is less than a fourth threshold, determining that the milk state is the room temperature state by the processor, wherein the fourth threshold is less than the third threshold.

5. The control method according to claim 1, wherein the step of controlling, by the processor, the heating component to heat the liquid in the heating box according to the heating temperature and/or the countdown length and continuously controlling the driving component to drive the milk shaking component and the baby bottle to move comprises:
when the baby bottle is made of glass, an amount of the milk is a first volume, and the milk state is the refrigerated state, determining that the heating temperature is a first heating temperature and the countdown length is a first countdown length by the processor;
when the baby bottle is made of plastic, the amount of the milk is the first volume, and the milk state is the refrigerated state, determining that the heating temperature is a second heating temperature and the countdown length is a second countdown length by the processor;
when the baby bottle is made of silicone, the amount of the milk is the first volume, and the milk state is the refrigerated state, determining that the heating temperature is a third heating temperature and the countdown length is a third countdown length by the processor;
when the baby bottle is made of the glass, the amount of the milk is a second volume, and the milk state is the refrigerated state, determining that the heating temperature is a fourth heating temperature and the countdown length is a fourth countdown length by the processor; and
when the baby bottle is made of the glass, the amount of the milk is the second volume, and the milk state is the room temperature state, determining that the heating temperature is a fourth heating temperature and the countdown length is a fifth countdown length;
wherein the second heating temperature is not less than the first heating temperature, the third heating temperature is not less than the second heating temperature, the second countdown length is greater than the first countdown length, the third countdown length is greater than the second countdown length, and the fourth countdown length is greater than the fifth countdown length.

6. The control method according to claim 1, wherein the step of controlling, by the processor, the heating component to heat the liquid in the heating box according to the heating temperature and/or the countdown length and continuously controlling the driving component to drive the milk shaking component and the baby bottle to move comprises:
obtaining, by the processor, a current temperature of the liquid in the heating box;
when the current temperature is less than the heating temperature, controlling the heating component to continue to heat the liquid in the heating box by the processor; when the current temperature is not less than the heating temperature, controlling the heating component to stop heating the liquid in the heating box by the processor; and
controlling, by the processor, the driving component to drive the milk shaking component and the baby bottle to move within the countdown length; and when the countdown length ends, controlling the driving component to stop driving the milk shaking component and the baby bottle to move by the processor.

7. The control method according to claim 1, wherein the processor first controls the heating component to stop heating the liquid in the heating box, and then controls the driving component to stop driving the milk shaking component and the baby bottle to move.

8. The control method according to claim 1, wherein the step of controlling, by the processor, the heating component to heat the liquid in the heating box according to the heating temperature and/or the countdown length and continuously controlling the driving component to drive the milk shaking component and the baby bottle to move comprises:
within the countdown length, controlling the heating component to heat the liquid in the heating box and controlling he driving component to drive the milk shaking component and the baby bottle to move by the processor, and when the countdown length ends, controlling the heating component to stop heating the liquid in the heating box and controlling the driving component to stop driving the milk shaking component and the baby bottle to move by the processor; or
obtaining the current temperature of the liquid in the heating box by the processor, and when the current temperature is less than the heating temperature, controlling the heating component to continue heating the liquid in the heating box and controlling the driving component to continue to drive the milk shaking component and the baby bottle to move by the processor, and when the current temperature is not less than the heating temperature, controlling the heating component to stop heating the liquid in the heating box and controlling the driving component to stop driving the milk shaking component and the baby bottle to move by the processor.

9. A control method of a milk warmer for warming milk, wherein the milk warmer comprises a processor, a driving component, a milk shaking component, a heating component, and a heating box, wherein the processor is electrically connected to the driving component and the heating component, the milk shaking component is disposed in the heating box, the driving component is connected to the milk shaking component, the processor is configured to control the driving component to drive the milk shaking component to move, the milk shaking component is configured to accommodate a baby bottle, the heating box is configured to store a liquid, the processor is configured to control the heating component to heat the liquid in the heating box, and when the liquid is stored in the heating box and the baby bottle is placed in the milk shaking component, the liquid in the heating box is in contact with an outer surface of the baby bottle; wherein the control method comprising steps:
controlling, by the processor, the driving component to drive the milk shaking component and the baby bottle to move according to a first instruction for a first predetermined time period;
obtaining, by the processor, a temperature change value of the liquid in the heating box during the first predetermined time period, when driving the driving component to drive the baby bottle;
determining, by the processor, a milk state of the milk in the baby bottle according to the temperature change value, wherein the milk state is a refrigerated state or a room temperature state;
determining, by the processor, a milk warming strategy according to the milk state of the milk in the baby bottle; and
controlling, by the processor, the heating component to heat the liquid in the heating box according to the milk warming strategy, and continuously controlling the driving component to drive the milk shaking component and the baby bottle to move.

10. The control method according to claim 9, wherein the step of controlling, by the processor, the heating component to heat the liquid in the heating box according to the milk warming strategy and continuously controlling the driving component to drive the milk shaking component and the baby bottle to move comprises:
when the processor determines that the milk state of the milk in the baby bottle is the refrigerated state, controlling the driving component to drive the milk shaking component and the baby bottle to move according to a second predetermined time period and/or controlling the heating component to heat the liquid in the heating box according to the second predetermined time period; and
when the processor determines that the milk state of the milk in the baby bottle is the room temperature state, controlling the driving component to drive the milk shaking component and the baby bottle to mover according to a third predetermined time period and/or controlling the heating component to heat the liquid in the heating box according to the third predetermined time period;
wherein the second predetermined time period is greater than the third predetermined time period.

11. The control method according to claim 10, wherein the processor controls the driving component to drive the milk shaking component and the baby bottle to rotate at a first rotating speed in the first predetermined time period, the processor controls the driving component to drive the milk shaking component and the baby bottle to rotate at a second rotating speed in the second predetermined time period or the third predetermined time period, and the first rotating speed is not less than the second rotating speed.

12. The control method according to claim 10, wherein the processor first controls the heating component to stop heating the liquid in the heating box and then controls the driving component to stop driving the milk shaking component and the target bottle to move.

13. The control method according to claim 9, wherein the milk warmer further comprises a temperature sensor, the temperature sensor is disposed in the heating box, the temperature sensor is electrically connected to the processor, and the temperature sensor is configured to detect a current temperature of the liquid in the heating box;
wherein the processor is configured to control the temperature sensor to detect the current temperature of the liquid in the heating box and obtain the current temperature of the liquid in the heating box from the temperature sensor.

14. The control method according to claim 13, wherein the milk shaking component is disposed above the heating component, the milk shaking component is disposed in a middle of a bottom portion of the heating box, the temperature sensor is disposed at an edge of the heating box, and the temperature sensor and the milk shaking component are spaced apart from each other.

15. The control method according to claim 13, wherein the step of controlling, by the processor, the heating component to heat the liquid in the heating box according to the milk warming strategy, and continuously controlling the driving component to drive the milk shaking component and the baby bottle to move comprises:
obtaining, by the temperature sensor, the current temperature of the liquid in the heating box;
comparing, by the processor, the current temperature of the liquid in the heating box with a temperature defined in the warming milk strategy;
when the current temperature is less than the temperature defined in the warming milk strategy, controlling the heating component to continue to heat the liquid in the heating box by the processor; and
when the current temperature is not less than the temperature defined in the warming milk strategy, controlling the heating component to stop heating the liquid in the heating box.

16. The control method according to claim 9, wherein the driving component is fixed to the milk shaking component through a rotating shaft, the driving component is disposed below the heating box and the heating component, and the rotating shaft passes through a bottom portion of the heating box and is fixed to the milk shaking component.

17. The control method according to claim 9, wherein the milk warmer further comprises a reminding component, and the reminding component is electrically connected to the processor;
wherein after the processor completes warming milk according to the milk warming strategy, when the processor obtains that the baby bottle is still placed in the milk shaking component, the processor controls the reminding component to send reminding information.

18. A control method of a milk warmer for warming milk, wherein the milk warmer comprises a processor, a memory, a driving component, a milk shaking component, a heating component, and a heating box; wherein the processor is electrically connected to the driving component, the memory, and the heating component, the milk shaking component is disposed in the heating box, the driving component is connected to the milk shaking component, the processor is configured to control the driving component to drive the milk shaking component to move, the milk shaking component is configured to accommodate a baby bottle, the heating box is configured to store a liquid, the processor is configured to control the heating component to heat the liquid in the heating box, when the liquid is stored in the heating box and the baby bottle is placed in the milk shaking component, the liquid in the heating box is in contact with an outer surface of the baby bottle, the memory stores a milk warming strategy, and the milk warming strategy at least comprises a target strategy corresponding to a milk state;
wherein the control method comprising: a milk state obtaining step and a milk warming step;
wherein the milk state obtaining step comprises controlling, by the processor, the driving component to drive the milk shaking component and the baby bottle placed in the milk shaking component to move, obtaining a temperature change value of the liquid in the heating box, and determining the milk state according to the temperature change value; and
wherein the milk warming step comprises determining, by the processor, the target strategy corresponding to the milk state from the milk warming strategy stored in the memory according to the milk state, controlling the heating component to heat the liquid in the heating box according to the target strategy, and continuously controlling the driving component to drive the milk shaking component and the baby bottle placed in the milk shaking component to move.

19. The control method according to claim 18, wherein the milk worming strategy comprises a duration strategy, and the milk warming step comprises:
determining, by the processor, a target duration corresponding to the milk state from the milk warming strategy stored in the memory according to the milk state, and continuously controlling, according to the target duration, the driving component to drive the milk shaking component and the baby bottle placed in the milk shaking component to move until the target duration ends.

20. The control method according to claim 18, wherein the milk warming strategy comprises a temperature strategy, and the milk warming step comprises:
determining, by the processor, a target temperature corresponding to the milk state from the memory according to the milk state, and controlling the heating component to heat the liquid in the heating box according to the target temperature until a current temperature of the liquid in the heating box reaches the target temperature.
